(19) United States
(12) Patent Application Publication
(10) Pub. No.: US 2010/0313273 A1
(43) Pub. Date: Dec. 9, 2010

(54) Securing or Protecting from Theft, Social Security or Other Sensitive Numbers in a Computerized Environment

(76) Inventor: Walter Stewart Freas, Knoxville, MD (US)

Correspondence Address: AQCA Corporation, P.O. Box 458, Jefferson, MD, 21755, US

(21) Appl. No.: 12/573,126

(22) Filed: Oct. 4, 2009

Related U.S. Application Data
(60) Provisional application No. 61/184,786, filed on Jun. 6, 2009.

(51) Int. Cl. G06F 21/00; G06F 17/30

(52) U.S. Cl. 726/26; 707/E17.014; 707/769

(57) ABSTRACT

Use of a database/website or similar system, to store identification or other sensitive numbers, together with email addresses or other contact data in a linked association, for remote access by an organization to initiate usage notification to the true owner of the number collected, and to check a Fraud Alert status or similar setting for the number, and to compare the email address or other contact data obtained from a customer, not to include a PIN, to data stored in the database with the number collected, all of which, depending on the data components entered, will achieve deterrence of identity theft, rapid notification of number usage, rapid communication of a fraud alert or similar status, success or failure in obtaining or establishing an acceptable level of certainty that the customer is the true owner of the number, and a locking/unlocking capability for the number owners within the system domain.

### CROSS REFERENCE TO RELATED APPLICATIONS

This application claims the benefits of Provisional Patent Application 61/184,786 filed on Jun. 6, 2009, entitled “Social Security Number usage, monitoring, and/or reporting process using email notifications, without the use of a PIN.”, the entire contents of which are incorporated herein by reference.

This application distinguishes itself from Published Application 20070110282, as that Application and its Claims are strictly limited to the use of a PIN, or Personal Identification Number, to achieve security for Social Security Numbers.

This application distinguishes itself from Published Application 20070271221, as that Application contains Primary or Dependant Claims each of which specifically state either;
a) “such that ownership of the one or more social security numbers is proven”, or
“a method of verifying ownership of the social security number”
   In contrast to those Claims, Claim number 4 of this Application specifically states “ . . . to succeed or fail in obtaining or establishing an acceptable level of certainty that the customer is the true owner of the number involved or that it is appropriate to proceed under that assumption”.
   This Application contains no Claim that ownership will be proven or verified.

### STATEMENT OF FEDERALLY SPONSORED RESEARCH/DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention evolves from the present day issue of Identity Theft involving the use of another person's Social Security Number (SSN) to gain some financial or material advantage at the expense of the true owner of the number. The SSN is the primary identifier used throughout society for identification purposes, and its security for individual owners is extremely important.

The use of computers and the Internet throughout society makes available new techniques for combating Identity Theft. The widespread use of email throughout society makes it possible to rapidly communicate identity transactions to virtually anyone, including the rightful owners of the SSN or other numbers involved in the transaction.

### BRIEF SUMMARY OF THE INVENTION

The present invention consists of associating email addresses, or other unique contact data, with individual Social Security Numbers, or other sensitive numbers, such as credit card account numbers, together in a database such that the use of the number by a customer may be transmitted by a registered and approved number requesting entity over the internet or by other transmission facilities, to the database entity, and email or other notification may then be sent from the database entity to the true owner of the number, if they have registered their number and email address or other contact data into the database.

In the case where the database entity has already confirmed ownership of a Social Security Number or other number, the invention would also allow the number requesting entity to submit the number collected, together with the email address or other identifier, which may be entered by the customer for security purposes, in order to succeed or fail in obtaining or establishing an acceptable level of certainty that the customer is the true owner of the number involved or that it is appropriate to proceed under that assumption. The database entity would then relay to the number requesting entity either a positive or negative response to show that the acceptable level of certainty has or has not been achieved by comparison of data received to data stored in the database.

### BRIEF DESCRIPTION OF THE SEVERAL VIEWS OF THE DRAWING

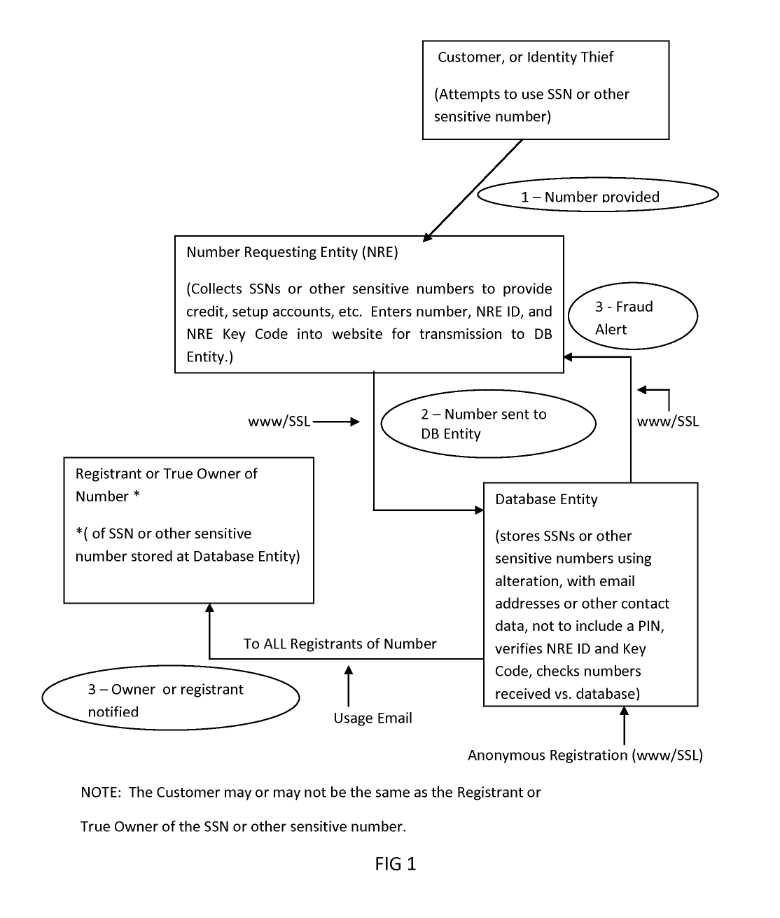

Drawing FIG. 1 shows a block diagram of the basic SSN usage monitoring and reporting system, and shows the communication and data transfer between the four main entities, which include the Customer, the Number Requesting Entity (NRE), the Database Entity, and the Registrant or True Owner of the SSN or other sensitive number.

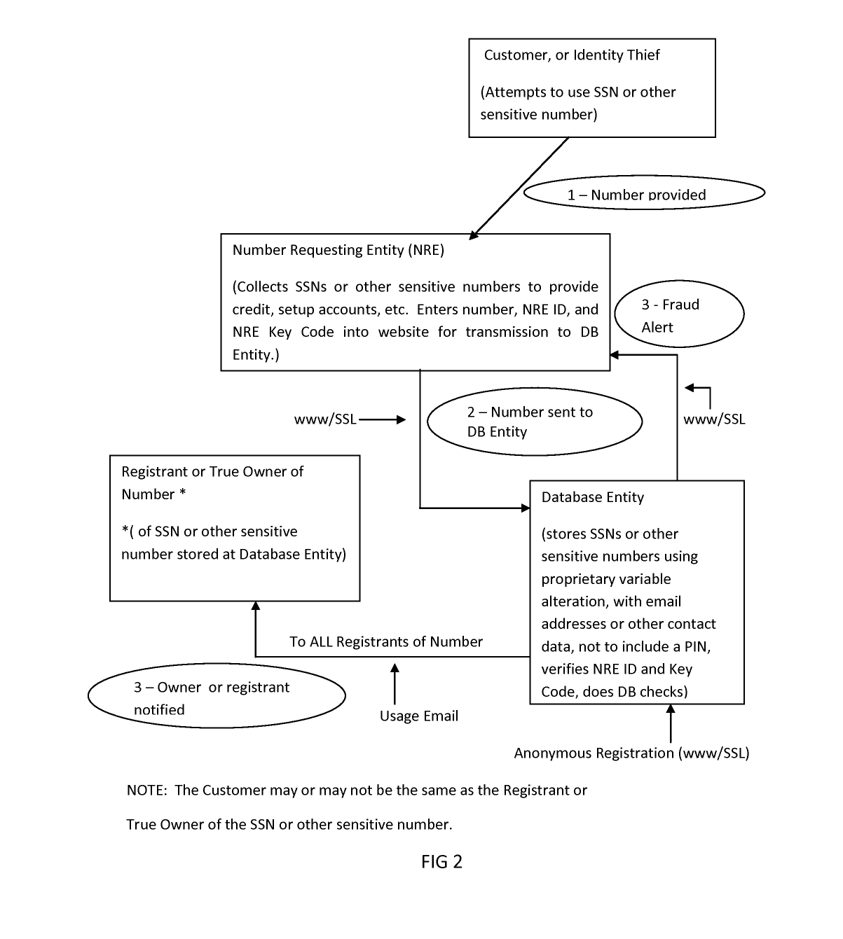

Drawing FIG. 2 is identical to FIG. 1 except that the number alteration method used by the Database Entity prior to storage is a proprietary variable alteration method.

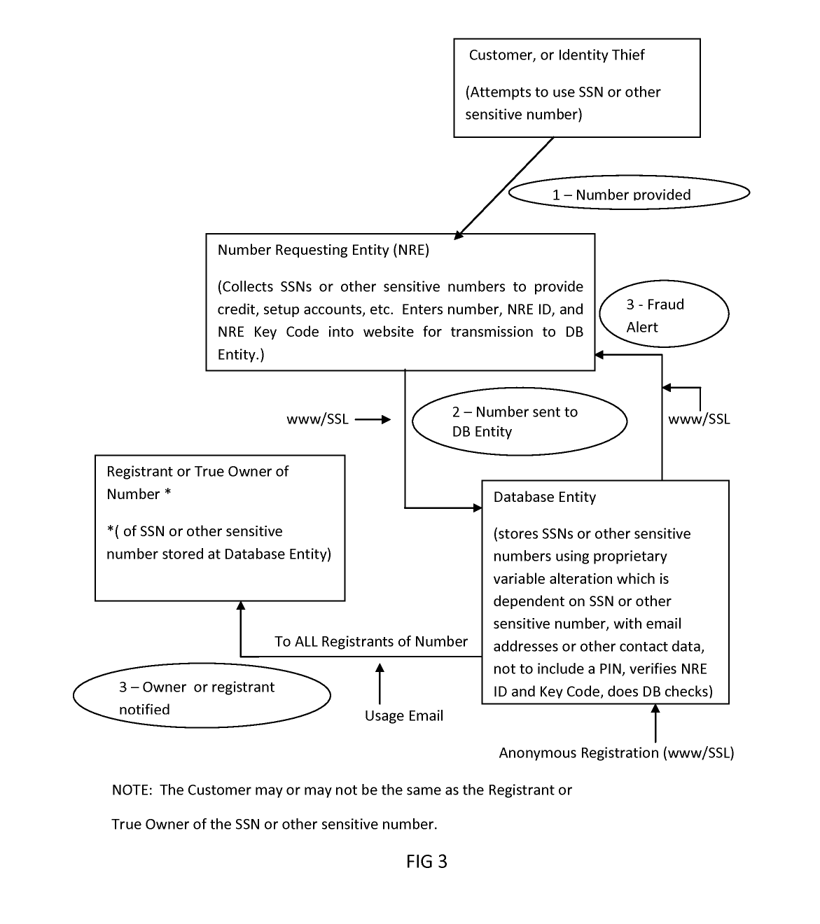

Drawing FIG. 3 is identical to FIG. 2 except that the number alteration method used by the Database Entity prior to storage is a proprietary variable alteration method in which the alteration method used is dependent on the SSN or other sensitive number itself.

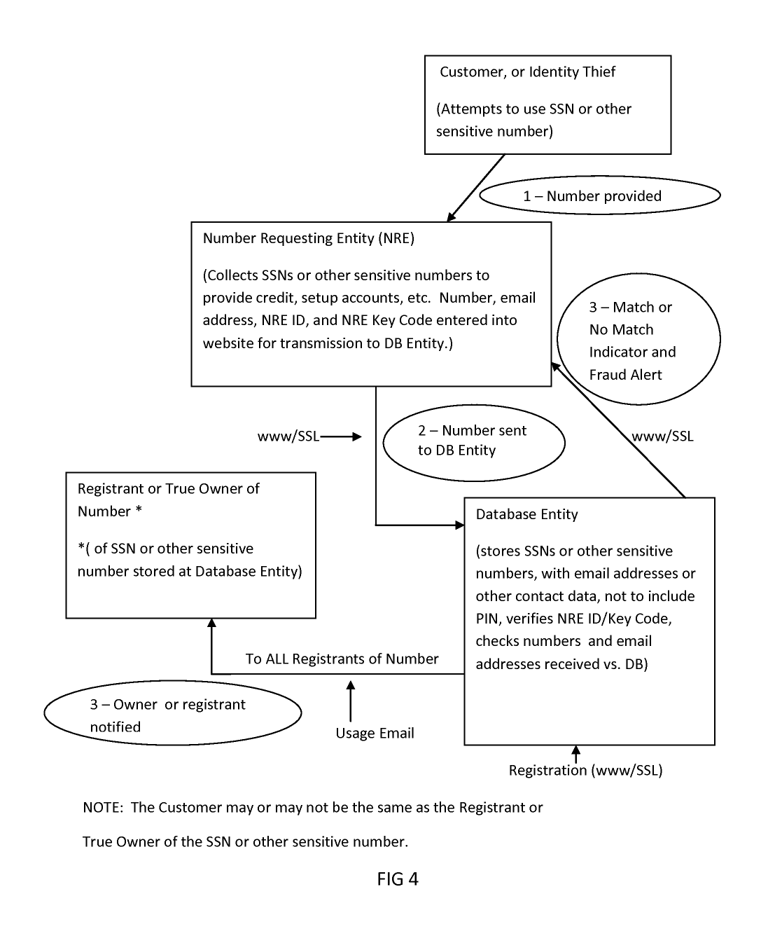

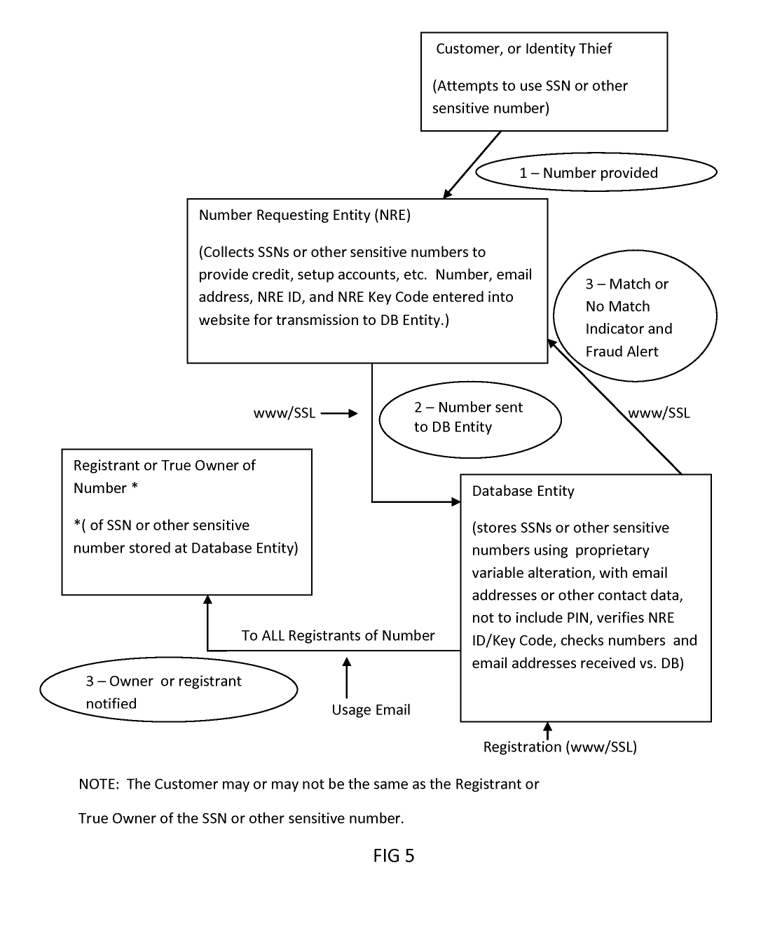

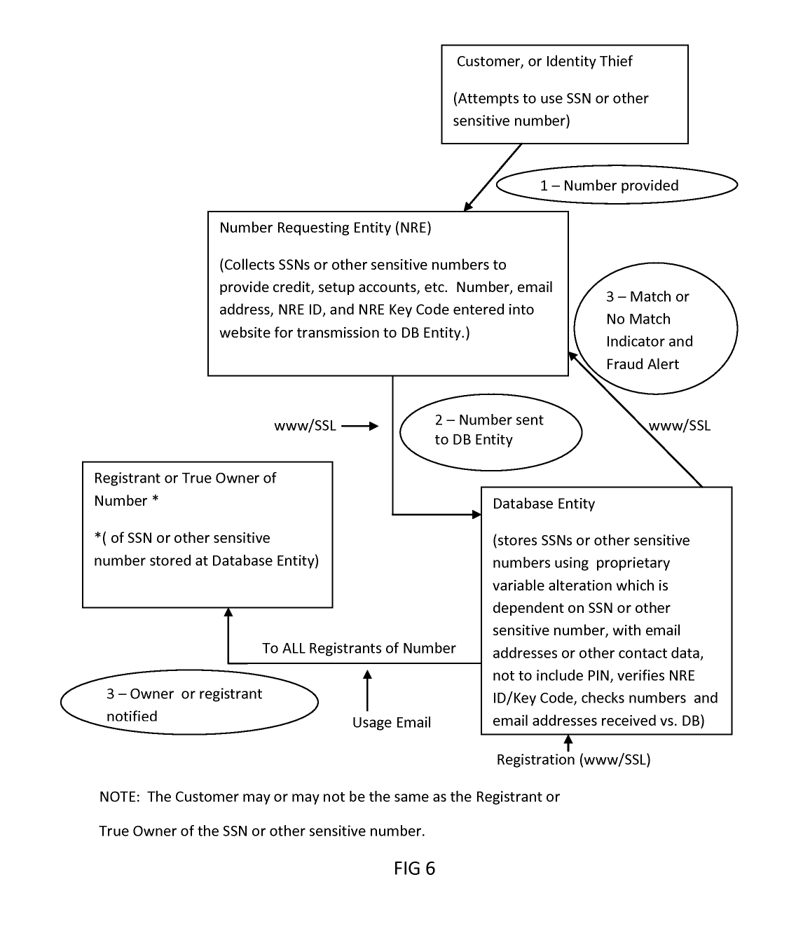

Drawing FIG. 4 is identical to Drawing FIG. 1 except that the email address of the customer is also collected and transferred to the Database Entity, allowing the SSN or other sensitive number to be validated via a “match” or “no match” indication. This lone addition or difference is also present in Drawing FIG. 5 vs FIG. 2, and in Drawing FIG. 6 vs FIG3. It is noteworthy that Drawing FIGS. 1 thru 6 correspond to claims 1 thru 6, respectively.

### DETAILED DESCRIPTION OF THE INVENTION

The present invention consists of the establishment of a database entity in combination with a website, or an equivalent configuration. The database entity would allow its customers to register their Social Security Numbers, or other sensitive numbers, into the database together with an email address or other contact data. The registrants would be permitted to complete their registration anonymously for number usage monitoring and reporting services (see FIG. 1). Anonymous registration serves to protect the identities of the customers and makes the database entity more resilient to loss of data. The customers would also be permitted to set a Fraud Alert value to either ON or OFF for their registered number.

In order to compensate for potentially fraudulent registrations into the database due to allowance of anonymous registrations, various safeguards would be used, such as confirmation of ownership for duplicate registrations, Fraud Alert status overrides, giving preference to any ON setting for a given number, subsequent resolution of conflicting settings, and an exclusion option allowing customers to exclude their numbers from service.

The website would be made accessible to any business or number requesting entity (NRE) having Internet access which has also registered its identifying information with the database entity, and has had its information confirmed and approved by the database entity.

Whenever a customer provides the NRE a Social Security Number or other sensitive number, the NRE could enter the number into the website to execute an email or other transmission to any persons who have registered that number and an email address or other contact data into the database, and also to be notified if the Fraud Alert setting is ON for the number entered (see FIG. 1). For security purposes in the case of fraudulent registrations which could reside in the database, the information contained in the email notification or other transmission would be limited, particularly regarding the physical location of the number collection, but sufficient enough to alert the true owner of the number being used so that corrective action could be taken.

In the case where the database entity has confirmed the actual ownership of the Social Security Number or other number, which would be a separately offered service and would exclude anonymous registration, the NRE would have the option of submitting both the number collected and the associated email address or other contact data, obtained from the customer, and possibly entered by the customer for security purposes (see FIG. 4,5,6), enabling the NRE to succeed or fail in obtaining or establishing an acceptable level of certainty that the customer is the true owner of the number involved or that it is appropriate to proceed under that assumption.

Upon receipt of the data by the database entity, the database entity would send a response to the NRE to show that the acceptable level of certainty has or has not been achieved by comparison of the data received to data stored (see FIG. 4,5,6).

The database entity and its website would make utilization of SSL or other encryption technology for secure transmission of data between its customers or NREs and itself.

This invention differs from previous systems or ideas in that it brings together and specifies numerous features and details which have never been documented together, or implemented together in a real environment, such as number alteration, anonymous registration, encryption, merchant ID and key codes, email notifications, fraud alerts, limiting the information contained in email notifications as a result of anonymous registrations.

Comprehensive use of this invention by the public and NREs would virtually eliminate identity theft.

1. Use of a system including data storage and remote interfacing to the data, to store registered Social Security Numbers or other sensitive numbers in altered form, with corresponding email addresses or other contact data, such that when a Social Security Number or other sensitive number collected from a consumer or customer, and a number requesting entity (NRE) ID and NRE key code, are entered into the website or other system by a NRE which is, subsequent to the data input, confirmed as registered and active using automated review of stored data, that data entry action initiates a search of the stored data and, upon successful location of the altered Social Security Number or other sensitive number, an email or other rapid notification is sent to all registrants, who are permitted to register anonymously and who have registered that Social Security Number or other sensitive number into the database, and a fraud alert status or similar status, which can be set by the registrant and is stored in the database, is returned to the NRE, allowing the NRE, the database entity, and the true owner of the Social Security Number or other sensitive number to 1) deter identity theft, 2) achieve rapid notification of number usage to the true owner of the number, and 3) rapidly communicate a fraud alert or similar status from the true owner of the number to the NRE.

2. The method of claim 1 above, where the alteration method is a unique and proprietary variable alteration method, such that the alterations made are not the same for each input number.

3. The method of claim 1 above, where the alteration method is a unique and proprietary variable alteration method, where the particular alteration used is determined by a value in the Social Security Number or other sensitive number itself.

4. Use of a system including data storage and remote interfacing to the data, to store registered Social Security Numbers or other sensitive numbers in altered form, with corresponding email addresses or other contact data, such that when a Social Security Number or other sensitive number collected from a consumer or customer, and a number requesting entity (NRE) ID and NRE key code, and the email address or other contact data are entered into the website or other system by or through a NRE which is, subsequent to the data input, confirmed as registered and active using automated review of stored data, that data entry action initiates a search of the stored data and, upon successful location of the altered Social Security Number or other sensitive number, an email or other rapid notification is sent to all registrants who have registered that Social Security Number or other sensitive number into the database, and a fraud alert status or similar status, which can be set by the registrant and is stored in the database, is returned to the NRE, and a match or no-match indication is returned to the NRE, allowing the NRE to succeed or fail in obtaining or establishing an acceptable level of certainty that the customer is the true owner of the number or that it is appropriate to proceed under that assumption, and allowing number owners to essentially lock and unlock their numbers within that system domain.

5. The method of claim 4 above, where the alteration method is a unique and proprietary variable alteration method, such that the alterations made are not the same for each input number.

6. The method of claim 4 above, where the alteration method is a unique and proprietary variable alteration method, where the particular alteration used is determined by a value in the Social Security Number or other sensitive number itself.
